(19) United States
(12) Patent Application Publication
(10) Pub. No.: US 2015/0153011 A1
(43) Pub. Date: Jun. 4, 2015

(54) PORTABLE LED LAMP

(71) Applicant: M. Heyer GmbH Applikator-Systeme, Mark Erlbach (DE)

(72) Inventors: Manfred Heyer, Markt Erlbach-Eschbach (DE); Petra Knoller, Stuttgart (DE)

(73) Assignee: M. Heyer GmbH Applikator- Systeme, Markt Erlbach (DE)

(21) Appl. No.: 14/093,722

(22) Filed: Dec. 2, 2013

(51) Int. Cl. F21L 4/08; F21V 23/04; F21L 14/00

(52) U.S. Cl. CPC F21L 4/08; F21L 14/00; F21V 23/04; F21Y 2101/02

(57) ABSTRACT

The invention relates to a portable, stand-up type LED lamp for hardening or curing of photochemically hardenable nail polish, said lamp comprising a flat lamp body provided with an illuminated panel (10) accommodating a plurality of light emitting diodes (9), an illuminated panel cover (7,7) secured on the edges of the illuminated panel by means of hinges located at opposite sides, wherein the illuminated panel cover (7,7) being divided to form two wings (7) of equal length—measured from hinges to the center—said wings (7) of the illuminated panel cover (7,7) designed so as to stand up in a position essentially perpendicular to the illuminated panel in a manner that jointly with the lamp body they form a bridge structure with said illuminating panel pointing downward, as well as a power supply unit and a switching element (3) to switch the lamp on or off.

The invention relates to a portable, stand-up type LED lamp for hardening or curing of photochemically hardenable nail polish, said lamp comprising a flat lamp body provided with an illuminated panel accommodating a plurality of light emitting diodes, an illuminated panel cover secured on the edges of the illuminated panel by means of hinges located at opposite sides, wherein the illuminated panel cover being divided to form two wings of equal length—measured from hinges to the center—said wings of the illuminated panel cover designed so as to stand up in a position essentially perpendicular to the illuminated panel in a manner that jointly with the lamp body they form a bridge structure with said illuminating panel pointing downward, as well as a power supply unit and a switching element to switch the lamp on or off.

Especially in nail care studios so-called UV gels are used for nail polishes, said gels containing methacrylic ester as bonding agent and can be hardened photo-chemically. These gels are applied professionally and hardened locally. As a rule, they last until the nails have “grown out”. If they are to be removed earlier aggressive agents are needed.

Aside from the UV gels there are so-called soak-off polishes that also contain methacrylic acid derivatives and harden when exposed to UV light. Other than the UV gels which can only be removed by filing soak-off polishes can be removed with the help of solvents, for example acetone. The durability of these soak-off polishes is approximately two weeks as a rule, following this they must be renewed.

Common to both nail polish types is that they are capable of hardening when exposed to UV light.

By adding photoinitiators the wavelength needed for nail polish hardening can be increased into the visible zone so that visible light can be used, for example in the blue or violet region of the spectrum. An appropriate wavelength is 405 nm, i.e. a violet light.

UV gels and soak-off polishes are usually applied by professional users only. Reason for this is that the polishes to some extent contain toxic substances and that UV light is used that may cause burns in the event of an intensive exposure. In the meantime, however, UV gels and soak-off polishes have been successfully manufactured in such a way that they do no longer contain toxic components. Moreover, due to the addition of photoinitiators the wavelength required for hardening can be increased such that the light is in the visible region of the spectrum. As a result of this UV gels and soak-off polishes are marketable for sale to the average consumer as well.

Nevertheless, to be able to apply these polishes the user needs to have a lamp producing light that causes the polish applied to the nail to harden quickly. Although polishes of this type would also harden when exposed to normal daylight such a hardening process, however, would take a long time such that surface impairments are likely to occur during that time span. Therefore, the objective of the invention is to provide a lamp for home application purposes suited to bring about the setting of such photochemically hardenable polishes.

This objective is achieved by a lamp of the kind first mentioned above.

The size of the inventive lamp roughly corresponds to that of a normal multimedia telephone with the lamp being provided on its flat side with a plurality of light emitting diodes so as to form an illuminated panel. The LED lamp is portable, i.e. it can be easily taken along by the user, for instance in a handbag.

The LED lamp has a flat body of a size approximately corresponding to the dimensions of a cell phone, wherein said lamp body accommodates on one of its large surfaces an illuminated panel provided with a multitude of light emitting diodes.

For the purpose of protecting the illuminated panel the lamp is provided with a two-part illuminated panel cover secured via hinges arranged on the opposite sides of the illuminated panel. The illuminated panel cover is divided so as to form two wings of equal length measured from the hinges to the center. The wings of the illuminated panel cover may be folded out into an allowed position in a manner essentially at a right angle to the illuminated panel such that jointly with the lamp body they form a bridge structure with the illuminated panel pointing downward. To improve the lamp stability and measured up to the illuminated panel the fold out angle may slightly exceed 90°.

Moreover, the LED lamp is provided with a power supply and with at least one on/off switch.

The portable LED lamp according to the invention may, for example, operate on rechargeable or non-rechargeable batteries or on mains power. Preferred is a rechargeable battery or mains operation which requires the lamp to be provided preferably at the side of the lamp with a connection for a customary charging device or power pack.

The shape of the inventive lamp is preferably rectangular with the wings of the illuminated panel cover being designed so as to be essentially square. Other sizes are feasible as well.

The LED lamp according to the invention is preferably provided with at least one signaling light indicating the lamp operating state. Signaling lights and on/off switches may be arranged at the sides of the lamp, for example, but are preferably located on the lamp body side situated opposite the illuminated panel.

As per a preferred embodiment of the invention the inventive lamp is provided with a timer capable of being set to a certain exposure duration, for example 30, 60, 90, or 120 seconds or a longer time period. As a rule 120 seconds are sufficient for the UV hardenable polish to set. In this case a signaling light is also provided for the timer, said light indicating the operation and the end of the exposure time. In this context a longer exposure time may also be controlled individually via the on/off switch with this being indicated by means of a relevant signaling light.

In accordance with the invention the LED lamp emits light particularly in the blue, violet, or near UV region of the spectrum. A preferred wavelength is 405 nm.

The two wings of the illuminated panel cover may be secured to the lamp body by means of customary hinges. Expediently, the hinges are designed such that the wings are arrested or locked in place in a position roughly 90° to the illuminated panel. Aside from customary hinges living hinges may also be used.

The wings of the illuminated panel cover may moreover be equipped with feet/supports aimed at enhancing the stability. Such feet are expediently arranged at both ends of the non-secured side of the wings and consist of a non-slip material.

The application is started by bringing the lamp in operating position, i.e. unfolding the wings, following this the lamp is switched on. Unfolding the wings results in a bridge structure being formed under which the hand with polished nails is to be placed. Under influence of the light the polish applied to the nails hardens. After about two minutes the hardening process is completed and—unless this has not taken place automatically—the lamp can be switched off and folded up again.

The invention is explained in more detail by way of the enclosed figures.

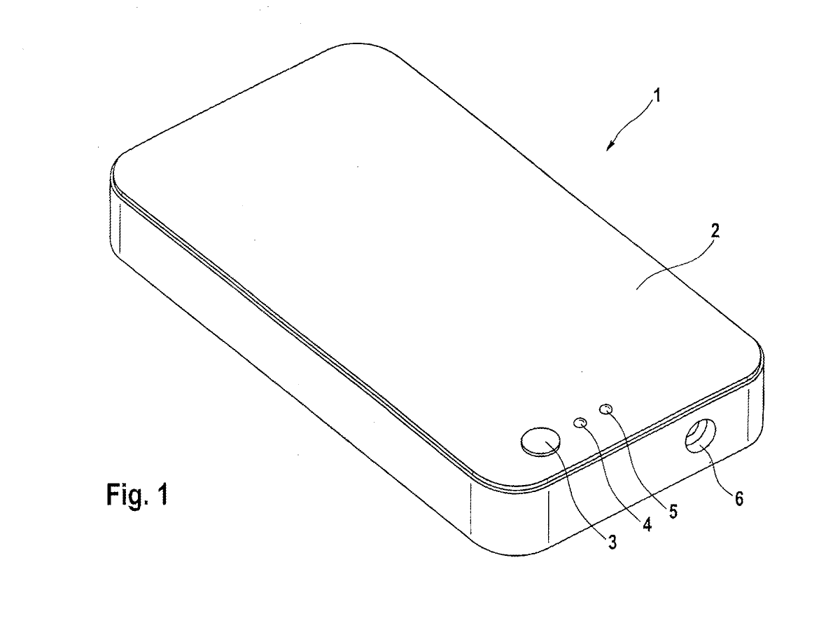

FIG. 1 shows an inventive LED lamp in folded-up state;

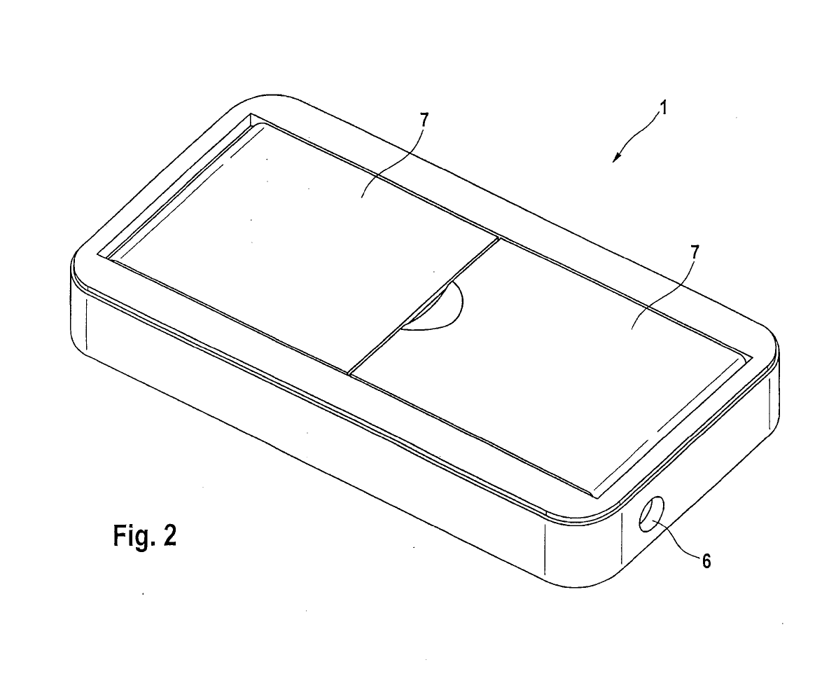

FIG. 2 shows the same lamp viewed from below, the lamp also being in folded-up state;

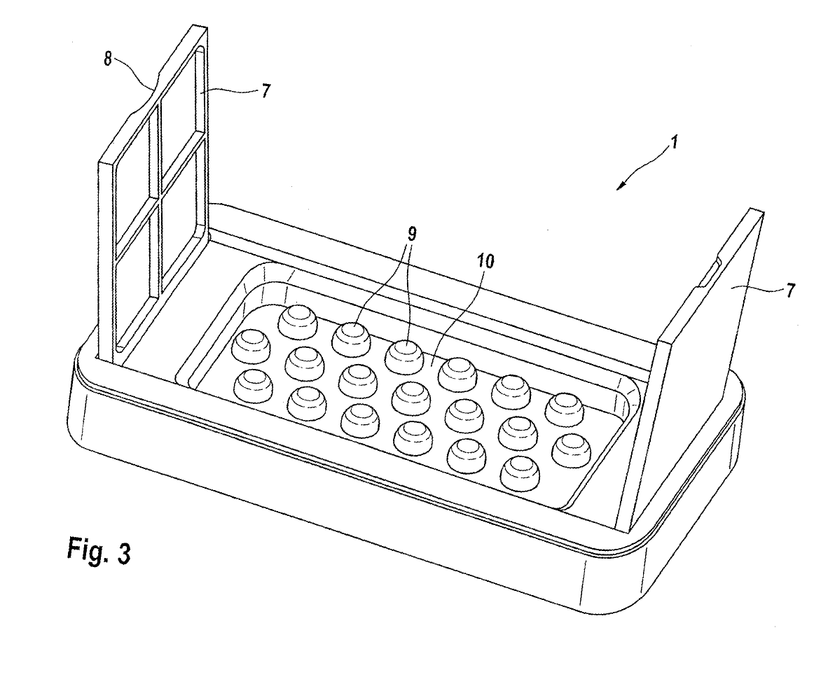

FIG. 3 is a perspective view of the inventive lamp with the wings of the illuminated panel cover being folded out;

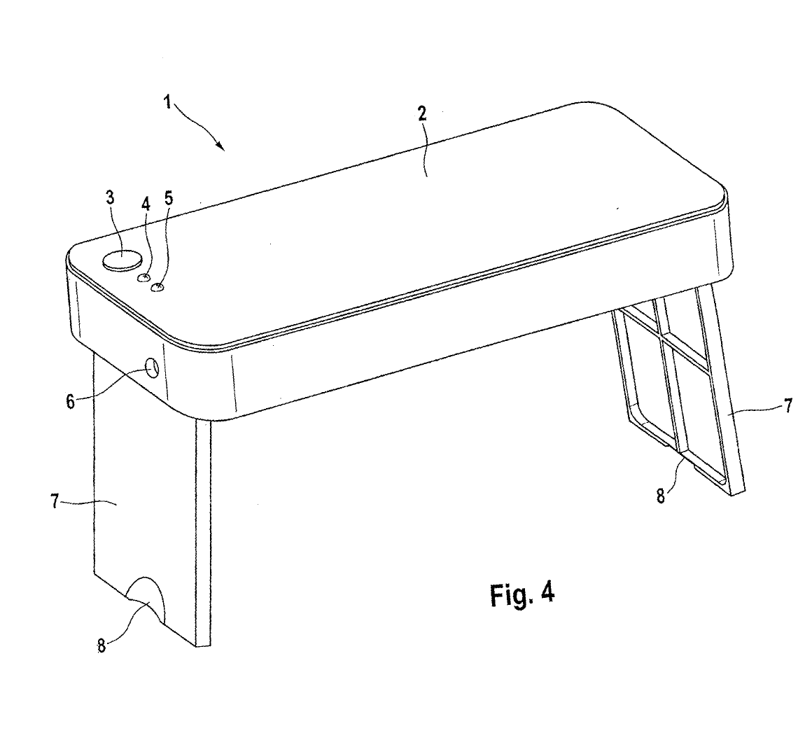

FIG. 4 illustrates the same lamp ready to operate.

The lamp 1 as shown in FIG. 1 has an essentially rectangular shape with edges rounded off, its size roughly corresponding to that of a cell phone. On the top side 2 an on/off switch 3 is flush-mounted as well as two signaling lights 4 and 5 designed as light emitting diodes. Reference numeral 6 denotes a connection for a battery charger or power pack.

FIG. 2 shows the underside of the lamp with the two wings 7 of the illuminated panel cover. At the front end of the body the electrical connection point for mains operation or hooking up a battery charging device can be seen again.

FIG. 3 illustrates as a perspective view the lamp 1 shown in FIGS. 1 and 2 in folded out state. The wings 7 of the illuminated panel cover are in upright roughly vertical position, with the numeral 8 denoting a manipulation aid in the form of a recess by means of which the wing can be folded out. Light emitting diodes 9 are arranged to form the illuminated panel 10 extending over the entire inner space of the bottom side of the lamp.

FIG. 4 shows lamp 1 in a state of operational readiness with wings in upright position, said wings together with the lamp body forming said bridge structure. On the top side 2 of the lamp the on/off switch 3 is arranged as well as two signaling lights 4 and 5, one for continued operation the other for the timer. Visible at the side is the electrical connection point. With the help of folded out wings 7 of the illuminated panel cover the lamp forms a bridge structure under which the hand with polished nails can be placed. Also visible are two recesses 8 arranged on the bottom edge of the two wings 7.

The representation shown in FIG. 4 shows the two wings located at an angle slightly greater than 90° to the illuminated panel. In this manner the stability of the lamp is enhanced.

It is to be understood that the inventive LED lamp is provided inside with the electronic components required for its operation.

1. Portable, stand-up type LED lamp (1) for hardening or curing of photochemically hardenable nail polishes, said lamp comprising a flat lamp body provided with an illuminated panel (10) accommodating a plurality of light emitting diodes (9), an illuminated panel cover (7,7) secured on the edges of the illuminated panel by means of hinges located at opposite sides, wherein the illuminated panel cover (7,7) being divided to form two wings (7) of equal length—measured from hinges to the center—said wings (7) of the illuminated panel cover (7,7) designed so as to stand up in a position essentially perpendicular to the illuminated panel (10) in a manner that jointly with the lamp body they form a bridge structure with said illuminating panel (10) pointing downward, as well as a power supply unit and a switching element (3) to switch the lamp on or off.

2. LED lamp according to claim 1, characterized in that the lamp is designed for mains operation or rechargeable battery operation.

3. LED lamp according to claim 1, characterized in that said lamp has an essentially rectangular shape and the wings (7) of the illuminated panel cover (7,7) have an essentially square shape.

4. LED lamp according to claim 1, characterized in that said lamp is provided with at least one signaling light (4) indicating the operational state.

5. LED lamp according to claim 1, characterized in that said lamp is provided with a timer controlling the exposure duration.

6. LED lamp according to claim 5, characterized in that the timer is connected to a signaling light (5).

7. LED lamp according to claim 5, characterized in that with respect to the exposure duration the timer is capable of being adjusted to a time interval of 30, 60, 90, or 120 seconds.

8. LED lamp according to claim 1, characterized in that the light emitting diodes (9) emit light in the blue to near UV region of the spectrum.

9. LED lamp according to claim 8, characterized in that the light emitting diodes (9) emit light at a wavelength of 405 nm.

10. LED lamp according to claim 1, characterized in that the wings (7) of the illuminated panel cover (7,7) can be arrested in a position of approximately 90° to the illuminated panel.

11. LED lamp according to claim 10, characterized in that the wings (7) of the illuminated panel cover (7,7) lock in place in the 90° position.

12. LED lamp according to claim 1, characterized in that the wings (7) of the illuminated panel cover (7,7) are provided with nonslip feet (8) at the non-secured side.
